(19) United States
(12) Patent Application Publication
(10) Pub. No.: US 2015/0273959 A1
(43) Pub. Date: Oct. 1, 2015

(54) Kick Start Tire Spoon and Grip for a Kick Start Tire Spoon

(71) Applicants: Bosch Automotive Service Solutions Inc., Warren, MI (US); Robert Bosch GmbH, Stuttgart (DE)

(72) Inventors: Michael White, Montgomery City, MO (US); James Gwilt, Blooming Prairie, MN (US); Robert Kochie, Dodge Center, MN (US); Larry Betcher, Northfield, MN (US); Robert Jensen, Clarks Grove, MN (US)

(21) Appl. No.: 14/670,954

(22) Filed: Mar. 27, 2015

Related U.S. Application Data
(60) Provisional application No. 61/971,577, filed on Mar. 28, 2014.

(51) Int. Cl. B60C 25/02

(52) U.S. Cl. CPC B60C 25/02

(57) ABSTRACT

A tire spoon for mounting or removing a tire from a wheel rim includes a spoon, and an elongated shaft. The spoon can be inserted between a wheel rim and a tire disposed thereon. The elongated shaft defines a lever arm that is distal from the spoon and that is configured to receive and transfer a lever force to the spoon to flex a portion of the tire about the wheel rim. A force member extends transversely from the shaft proximate to the spoon and between the spoon and the lever arm, and is configured to receive and transfer a pushing force to the spoon to drive the spoon between the tire and the wheel rim. A grip portion of the spoon has at least one groove configured to grip a surface of the tire and/or wheel rim.

### PRIORITY

This application claims the benefit of U.S. Provisional Patent Application No. 61/971,577 which was filed with the US. Patent and Trademark Office on Mar. 28, 2014, the disclosure of which is incorporated by reference herein in its entirety.

### TECHNICAL FIELD

This disclosure relates generally to automotive tools, and, more particularly, to tire installation and removal tools.

### BACKGROUND

Tire spoons have long been used to assist in the installation and/or removal of tires on wheel rims, and are commonly found in mechanic shops. A tire spoon customarily includes a spoon portion for manipulating a tire to be installed and/or removed on a wheel rim, and a shaft portion that provides leverage to the spoon portion. For example, U.S. Pat. No. 6,684,927, issued Feb. 3, 2004 to Kilskey, describes a tire mounting tool that includes a handle and a mounting end, the disclosure of which is incorporated by reference herein in its entirety.

FIG. 1 illustrates a known tire spoon being used to mount a tire upon a wheel rim. Generally, mounting a tire upon a wheel rim includes securing the wheel rim in a fixed position, such as via a clamping mechanism and/or by human force, and at least partially placing a first bead of the tire around the wheel rim. Tires have side walls, which are flexed in to order for the tires to fit over the wheel rim. The spoon portion of the tire spoon is placed between the tire and the wheel rim so as to manipulate portions of the first bead such that the first bead is fully placed around the wheel rim. This procedure is repeated for the second bead of the tire, such that the tire is fully installed on the wheel rim.

Generally, removing a tire from a wheel rim includes at least partially deflating the tire and securing the wheel rim in a fixed position. The spoon portion of the tire spoon is then placed between the tire and the wheel rim, and is used to progressively stretch the first bead over the wheel rim. This procedure is repeated for the second bead, and the tire is removed from the wheel rim.

Even with the aid of a tire spoon, the procedure of mounting or removing a tire on a wheel rim can be difficult, physically or mechanically intensive, and time consuming. Modern tires are being produced that have increasingly stiff side walls, so the amount of force needed to flex the beads of the tire over the wheel rim may be high. Additionally, even when the tire is properly secured, leverage provided by the tire spoon may be limited, and thus further limits the amount of force that can be applied to the tire. Furthermore, spoon portions of customary tire spoons are not optimized to grip a surface of the tire for efficient flexing. In some cases, applying the force necessary to manipulate a tire with stiff sidewalls may damage the tire, the tire spoon, and/or the wheel rim. What is needed, therefore, is a tire spoon optimized to provide leverage to a spoon portion, and a spoon portion that is optimized to grip a surface of the tire and/or wheel rim.

### SUMMARY

The following summary is included for the purpose of introducing features of a kick start tire spoon which are described in further detail in drawings, detailed description, and the claims, and should not be viewed as limiting the scope of this disclosure.

In order to facilitate installing and removing a tire from a wheel rim, a tire spoon includes a spoon configured to be inserted between a wheel rim and a tire disposed on the wheel rim. The spoon extends from an end of an elongated shaft which defines a lever arm at a location distal from the spoon. In an embodiment, a force member extends transversely out from the shaft at a location proximate to the spoon and between the spoon and the lever arm. The force member is configured to receive a pushing force, and transfer the pushing force to the spoon. The pushing force is transferred by the force member to the spoon to enable insertion of the spoon between the wheel rim and the tire. In an embodiment, the spoon includes a grip portion that can include at least one groove configured to grip at least one of the surface of the tire and the surface of the wheel rim.

A method of operating a tire spoon according to this disclosure, for example to install or remove a tire from a wheel rim, includes positioning a spoon portion of the tire spoon so that an end of the spoon portion is between the tire and the wheel rim, exerting a pushing force on the force member to drive the spoon portion between the tire and the wheel rim, and exerting a lever force on the lever arm of the shaft to enable to spoon to flex a portion of a side-wall of the tire about the wheel rim.

Further developments of the tire spoon and methods for using the tire spoon according to this disclosure are included in the detailed description, claims, and drawings.

### BRIEF DESCRIPTION OF THE DRAWINGS

The foregoing aspects and other features of the present disclosure are explained in the following description, taken in connection with the accompanying drawings.

FIG. 1 is an image of a customary tire spoon in use mounting a tire upon a wheel rim.

FIG. 2 is a perspective plan view of a tire spoon according to this disclosure.

FIG. 3 is a top plan view of the tire spoon of FIG. 2.

FIG. 4 is a front side plan view of the tire spoon of FIG. 2.

FIG. 5 is a bottom plan view of the tire spoon of FIG. 2.

FIG. 6 is a left side plan view of the tire spoon of FIG. 2.

FIG. 7 is a right side plan view of the tire spoon of FIG. 2.

FIG. 8 is a cross-section view of a spoon portion of a tire spoon in use installing a tire into a wheel rim, according to this disclosure.

FIG. 9A is a top view image of an exemplary spoon portion of a tire spoon according to this disclosure.

FIG. 9B is a perspective view image of an exemplary spoon portion of a tire spoon according to this disclosure.

FIG. 10 is an image of a tire spoon according to this disclosure in use for an operation on a tire.

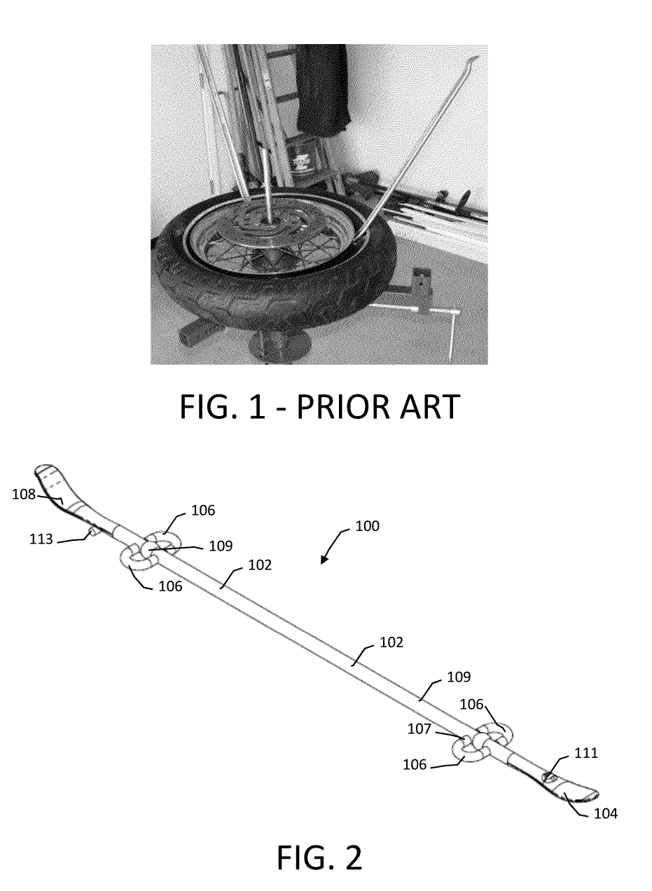

### DETAILED DESCRIPTION

For the purposes of promoting an understanding of the principles of the embodiments described herein, reference is now made to the drawings and descriptions in the following detailed description. No limitation to the scope of the subject matter is intended by the references. This disclosure also includes any alterations and modifications to the illustrated embodiments and includes further applications of the principles of the described embodiments as would normally occur to one skilled in the art to which this document pertains.

A tire spoon 100 according to this disclosure, as show in FIGS. 2-7, includes a shaft 102, a spoon portion 104 forming an end of the tire spoon 100, and a force member 106 extending out from the shaft 102. The shaft 102 may have a substantially cylindrical shape having a diameter of about 0.5 inches to about 1.5 inches, or more particularly about 1 inch. The shaft 102 may have a length of about 2 feet to about 4 feet, or more particularly about 2 feet 8 inches. Different cross-sections and lengths of the shaft 102 other than the dimensions described above may be utilized, such as for different wheel applications.

In one embodiment, the shaft 102 can be a rigid rod, a bar, or another substantially linear shape. In one embodiment, the shaft 102 may have a non-linear shape such as an arcuate shape, an angled shape, a shape that includes a bend such as an S-bend, or other types of shapes that may provide improved ergonomics without sacrificing leverage. The shaft 102 can be formed from iron, steel, a metal or metal alloy, a plastic, a composite, carbon fiber, a ceramic, or combinations thereof, such that the tire spoon 100 is sufficiently strong to resist bending under normal use. In different embodiments, the shaft 102 can have a substantially circular cross section, a rectangular cross section, a v-shaped cross section, a cross-section that varies along a length of the shaft 102, or other types of cross sections that fail to impede bending strength.

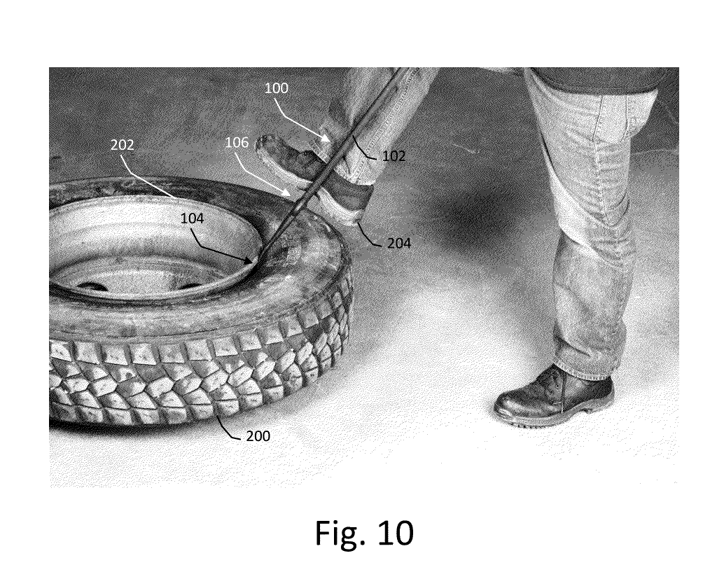

The force member 106 is configured to receive a pushing force or a “kick start”, e.g. from a hammer, a foot of a user, etc., and to transfer this pushing force to the spoon portion 104 to drive the spoon portion 104 between a bead of a tire and the wheel rim. An example of such a “kick start” is illustrated in FIG. 10 and is discussed in further detail below. The transfer of force increases the force applied to install/remove the tire from the wheel rim, and increases leverage provided by the tire spoon 100.

In the embodiment illustrated in FIGS. 2-7, a pair of force members 106 extends from the shaft 102 opposite each other. The force member(s) 106 extends from a location on the shaft 102 that is proximate to the spoon portion 104, such that the transfer of force from the force member 106 to the spoon portion 104 is facilitated.

In this embodiment, the force member 106 is a U-shaped member extending transversely out from the shaft 102 and having a leg 107 configured and positioned to receive the pushing force. The force member(s) 106 can have a transverse length from the shaft of approximately 1 inch to about 3 inches. Advantageously, the transverse length of the force member(s) provides a base sufficient to receive the pushing force. For example, the force member(s) 106 are preferably configured to have a transverse length sufficient to support a human foot.

The force member 106 optionally includes a support member 109 that is located between legs 107 of the U-shaped member and surrounding the shaft 102, and that is configured to support the force member 106 and/or the shaft 102 when the tire spoon 100 is in use. In one embodiment, the support member 109 is defined by providing additional material proximate to the portion of the leg 107 and/or shaft 102 that is configured to receive the “kick-start” or pushing force so as to resist bending and/or shear forces. In another embodiment, the support member 109 is formed from a material different from a material of the shaft 102. In one example, the support member 109 is formed from a material having a higher hardness and a lower flexibility than a material of the shaft 102. This configuration facilitates strengthening the tire spoon 100 in a region of the application of the “kick start” without sacrificing flexibility and resilience of the shaft 102. In one embodiment, the U-shaped member is further configured as a hanger usable to store the tire spoon 100 on, for instance, a tool rack.

Force members 106 of other shapes are also contemplated. In one embodiment, the force member 106 is contiguous with the shaft 102, such that the force member 106 and the shaft 102 can be formed in a common forming operation such as forging, stamping, molding, etc. In another embodiment, the force member 106 is adjoined to the shaft 102 by any customary method, such as by a weld, pin, threaded connection, etc. In an example, the force member 106 comprises a bent rod or tube having a diameter of about 1 inch. Various other diameters for such a rod or tubing of the force member 106 are also contemplated. The force member 106 can comprise a material similar to a material of the shaft 102, and/or a material different than the material of the shaft 102.

The spoon portion 104 adjoins an end of the shaft 102, and thus forms an end of the tire spoon 100. A first portion 107 of the shaft 102 that is distal from the spoon portion 104 may act as a lever arm 107 so as to provide leverage to the spoon portion 104. When the spoon portion 104 is inserted between a tire and wheel rim, the lever arm 107 is configured to receive a lever force, and transfer the lever force to the spoon portion 104, which enables the spoon portion 104 to flex a portion of the side-wall of the tire about the wheel rim.

In certain embodiments, the tire spoon 100 may include an additional spoon portion 108 adjoining an opposite end of the shaft 102 from the spoon portion 104, as illustrated in FIGS. 2-7, but in other embodiments, the opposite end of the tire spoon does not include an additional spoon portion. In one embodiment, the opposite end includes a handle, a hanger, or other acceptable end members as would be understood by one of ordinary skill in the art. In embodiments with an additional spoon portion 108, a second portion 109 of the shaft 102 that is proximate to the spoon portion 104 and distal form the additional spoon portion 108 is configured to act as a second lever arm 109.

In one embodiment, at least one of the lever arms 107, 109 additionally includes a grip configured to mechanically or frictionally engage with, for example, a hand of a user, or a lever member of a levering mechanism.

In one embodiment, the spoon portion 104 and the additional spoon portion 108 are configured with similar shapes. In the embodiment illustrated in FIGS. 2-7, the spoon portion 104 and the additional spoon portion 108 are configured with different shapes. For example, the spoon portion 104 can be configured with a first shape optimized to perform a first task, such as beginning a positioning of the first bead of the tire on the wheel rim, and the additional spoon portion 108 can be configured with a second shape optimized for a second task such as positioning the remainder of the first bead around the wheel rim.

The spoon portion 104 and/or the additional spoon portion 108 may additionally comprise further features that facilitate such operations. As illustrated in FIG. 4, the spoon portion 104 includes a convex bottom surface 120 that is configured to slip into the bead of the tire, and a protrusion 111 configured to engage and slide along an edge of the wheel rim and/or bead of the tire. During a tire installation or removal operation, it may be difficult to optimally and consistently locate a conventional tire spoon relative to the side wall of the tire and the rim of the wheel. The spoon portion of a conventional tire spoon may also slip during an operation, which can damage the tire or wheel rim, and presents a risk of injury to a user. The convex surface 120 and the protrusion facilitate initial insertion of the spoon portion between the bead of the tire and the wheel rim, while inhibiting slippage and accurately locating the spoon portion 104 between the tire and the wheel rim.

The additional spoon portion 108 includes a curved portion 115, a flat end portion 117 extending from the curved portion 115, and a bar 113 that is offset from and transverse to the shaft 102. In some operations, such as when the sidewalls of a tire are especially stiff, providing additional leverage to bend the side walls of the tire is beneficial. The bar 113 is configured to act as a leverage base or pivot point that can provide additional leverage. The flattened end portion 117 is configured to push against a surface of the tire or wheel rim in order to transfer such leverage to the sidewalls of the tire.

As illustrated in FIGS. 2-7, in certain embodiments, an additional force member 106 or pair of force members 106 extend(s) from a location proximate to the additional spoon portion 108. In other embodiments, the additional spoon portion 108 does not include force members. In one embodiment, a force member 106 proximate to the spoon portion 104 has a different shape and/or material than a shape and/or material of an additional force member 106 proximate to the additional spoon portion 108.

The spoon portions 104/108 can be adjoined to the end of the shaft 102 by any acceptable process. For example, the spoon portions 104/108 can be adjoined to the end of the shaft 102 by a weld, a pin, a threaded connection, a clamped connection, a tine, etc. In one embodiment, the spoon portion 104/108 and the shaft 102 are contiguously formed, e.g., from a metal forging, molding, casting, or stamping process. The spoon portion 104 can comprise similar materials as the shaft 102, and/or can comprise different materials. In one embodiment, a material of the spoon portion 104 is different than a material of the additional spoon portion 108.

In this embodiment, the spoon portion 104 includes a taper region 110 and a spoon region 112 (FIG. 4) that has a smaller thickness than the shaft 102. The taper region 110 includes a taper that extends from the shaft 102 to the spoon region 112. In this embodiment, the spoon region 112 includes a tine 114 embedded within the taper region 110 to add bending stiffness.

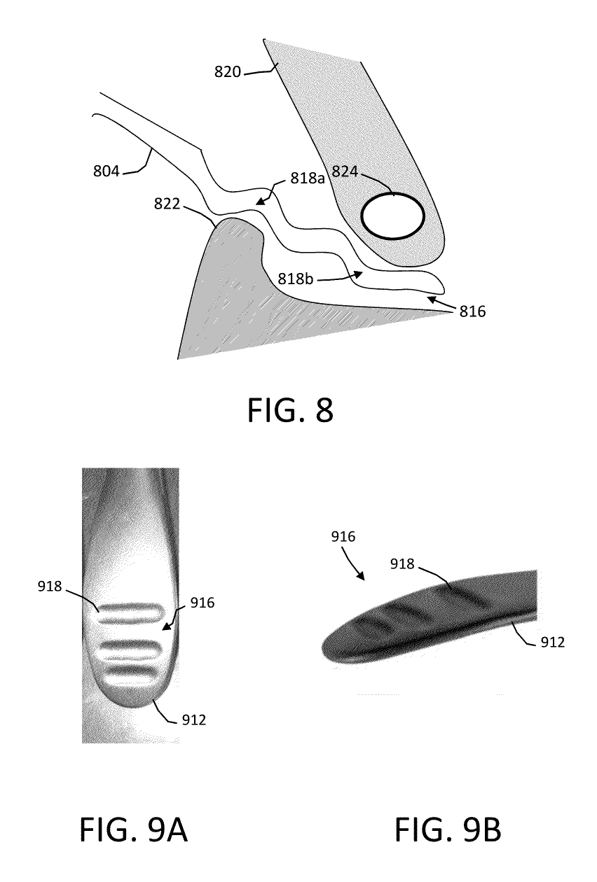

The spoon region 112 is defined by a substantially spoon-like shape configured to be placed between a tire and a wheel rim, such as for mounting or removing the tire from the wheel rim. In this embodiment, the spoon region 112 further includes a grip portion 116 that is configured to grip a surface of the tire and/or the wheel rim. In some embodiments, the grip portion 116 includes one or more grooves, but such grooves are not illustrated in FIGS. 2-7 for the purpose of clarity. Examples of a grip portions 116 having grooves are illustrated in FIGS. 8 and 9.

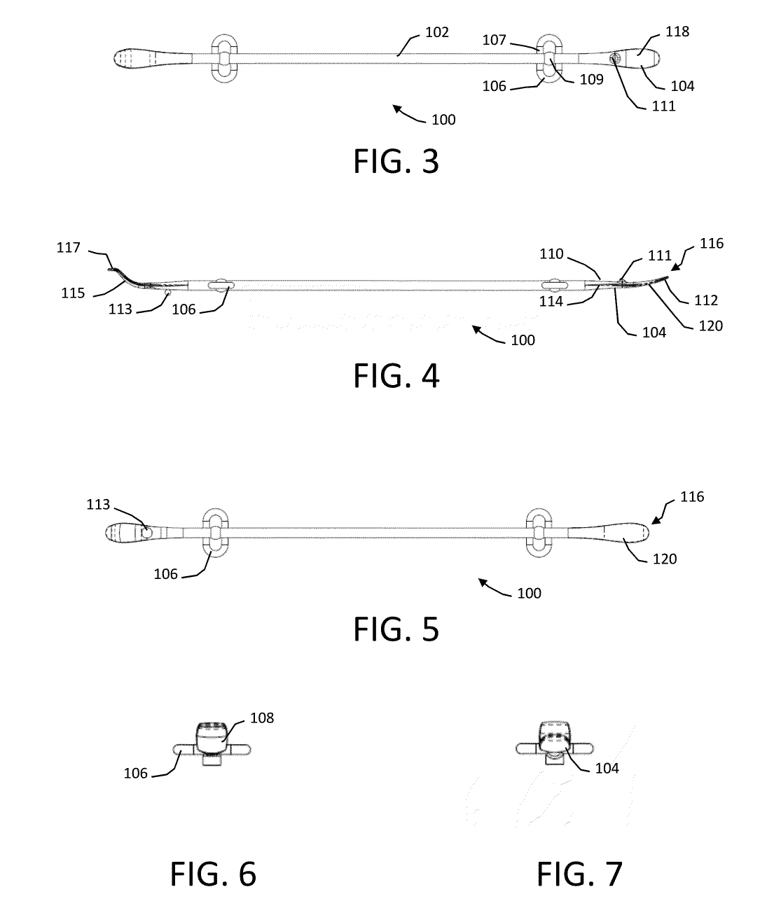

In one embodiment, the grip portion 116 includes at least one groove on a top surface 118 of the spoon region 112 (FIG. 3) or at least one groove on a bottom surface 120 of the spoon region 112 (FIG. 5). In one embodiment, the groove grip 116 includes at least one groove on each of the top surface 118 and bottom surface 120 of the spoon region 112.

The grip portion 116 is configured to grip at least one of a surface of the tire and a surface of the wheel rim when the tire spoon 100 is in use for mounting or removing the tire from the wheel rim. Additional grip while mounting or removing the tire can limit slippage of the spoon portion during use. Slippage can reduce installation/removal efficiency, lead to damage of the tire, wheel rim, or tire spool 100, such as by scratching, bending, tearing, etc., and may lead to injury of a user, e.g. if the spoon portion 104 slips out from the tire during use while a large force is applied to the tire spoon 100.

FIG. 8 depicts a cross-section view of a spoon portion 804 in use installing a tire 820 into a wheel rim 822. A groove grip 816 of the spoon portion 804 includes a groove pattern having grooves including a groove 818a and a groove 818b. Advantageously, the groove 818a is configured to grip the wheel rim 822 and/or the groove 818b is configured to grip a bead 824 of the tire 820 so as to inhibit slippage of the spoon portion 804 during use.

Additionally, by gripping the bead 824 via the groove 818b, and/or gripping the wheel rim 822 via the grove 818a, the groove grip 816 is configured to limit a depth of insertion of the spoon portion 804 between the tire 820 and the wheel rim 822. In an example, a user pushes on a force member to “kick start” the tire spoon in order to drive the spoon portion 804 between the tire 820 and the wheel rim 822. In other embodiments, the driving force may drive the tire spoon too far, such that the spoon portion 804 impacts on a rear surface of the tire 820, or such that the tire spoon is not optimally positioned. However, in this embodiment, the groove grip 816 engages with at least one of the bead 824 and the wheel rim 822 in order to limit a depth of insertion of the spoon portion 804 such that the spoon portion 804 is optimally located. In this embodiment, such depth limiting is due to at least one of (i) the groove 818b engaging with the bead 824, and (ii) the groove 818a engaging with the wheel rim 822.

In this embodiment, the grooves define a stepped shape, where each successive groove extends in a same direction from a preceding grove. This stepped shape enables the spoon portion 804 to ratchet the bead 824 into or out from position with the wheel rim 822.

FIGS. 9A and 9B are images of exemplary spoon portions 912 of tire spoons according to this disclosure. The spoon portions 912 include a grip portion 916. Various alternative groove patterns are contemplated. In the illustrated embodiments, a groove pattern is advantageously configured to cause friction and/or cause mechanical gripping on at least one the surface of the tire and/or the surface of the wheel well. Grooves 918 for the grip portions 916 can be formed using any acceptable process that would be known by one of ordinary skill in the art. For example, grooves 918 can be stamped, molded, etc., or may comprise material added to and/or removed from the spoon region.

In this embodiment, the groove grip 916 has a groove pattern, having three substantially parallel grooves. A groove grip having more or less than three grooves is also contemplated. In this embodiment, the groove 918 is substantially perpendicular to a longitudinal axis of a shaft of the tire spoon, but in other embodiments, the groove 918 can have other orientations. A groove 918 may have rounded ends, tapered ends, straight ends, or ends of other acceptable shapes. In one embodiment (not illustrated) at least two grooves in a groove pattern overlap. In one embodiment, at least one groove in a groove pattern is of a size configured to grip a particular tire or wheel rim, such that, in an example, different grooves in a groove pattern are configured for different tires or wheel rims.

FIG. 10 illustrates a tire spoon according to this disclosure that is in use in a tire installation operation. In one embodiment, a method of using a tire spoon 100 according to this disclosure includes positioning a spoon portion 104 at the end of a shaft 102 such that an end of the spoon portion is between the tire 200 and the wheel rim 202, and exerting a pushing force on a force member 106 extending from the shaft 102. In FIG. 10, a user is exerting pushing force on the force member 106 via a foot 204 to “kick start” the tire spoon 100. The force member 106 transfers the pushing force to the spoon 104, so that the spoon 104 is driven between the tire 200 and the wheel rim 202. In one embodiment, the spoon 104 is driven between the tire 200 and wheel rim until a grip portion (116 in FIG. 5) of the spoon 104 or a protrusion (113 in FIG. 5) extending from the shaft 102 engages at least one of the tire 200 and the wheel rim 202.

In performing mounting or removal operation on tires with stiff side-walls, the force necessary to flex the side-walls around the wheel rim can exceed what may be readily achieved with a conventional tire spoon. The pushing force “kick-starts” the insertion of the spoon portion, so that the tire spoon is usable even when the side-walls of the tire are especially stiff.

In one embodiment, a first spoon on the end of the shaft is usable to perform a first operation, such as beginning a positioning of a bead of the tire on the wheel rim, and a second spoon on a second end of the shaft is usable for a second operation, such as positioning a remainder of the bead of the tire on the wheel rim.

In one embodiment, the pushing force is a human force of a user, such as when a user “kicks” the force member, such as with a foot or hammer, in order to insert the spoon between the tire and the wheel rim. In another embodiment, a pushing mechanism is configured to exert the pushing force on the force member, such as in an automated tire mounting/removing machine.

It will be appreciated that variants of the above-described and other features and functions, or alternatives thereof, may be desirably combined into many other different systems, applications, or methods. Various presently unforeseen or unanticipated alternatives, modifications, variations or improvements may be subsequently made by those skilled in the art that are also intended to be encompassed by the disclosure. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It is claimed:

1. A tire spoon, comprising:
a spoon that is configured to be inserted between a wheel rim and a tire disposed on the wheel rim;
an elongated shaft that extends from the spoon, that defines a lever arm which is distal from the spoon and which is configured to receive a lever force and transfer the lever force to the spoon to enable the spoon to flex a portion of the tire about the wheel rim; and
a force member that extends transversely out from the shaft at a location on the shaft that is proximate to the spoon and between the spoon and the lever arm, and that is configured to receive a pushing force and transfer the pushing force to the spoon to enable the spoon to be driven between the tire and the wheel rim.

2. The tire spoon of claim 1, wherein the force member includes a pair of members extending radially from the shaft in opposite directions.

3. The tire spoon of claim 1, further comprising an additional spoon extending from an end of the shaft opposite said spoon.

4. The tire spoon of claim 3, further comprising an additional force member that extends transversely out from the shaft at a location on the shaft which is proximate to the additional spoon, and that is configured to receive a pushing force and transfer the pushing force to the additional spoon to enable the additional spoon to be driven between the tire and the wheel rim.

5. The tire spoon of claim 3, wherein the additional spoon includes:
a curved portion that extends from the end of the shaft opposite the spoon; and
a flat end portion that extends from the curved portion in a direction substantially parallel with the shaft.

6. The tire spoon of claim 1, wherein the spoon includes:
a spoon region having a thickness that is less than a thickness of the shaft; and
a taper region between the spoon region and the shaft that has a thickness that transitions from the thickness of the shaft towards the thickness of the spoon region.

7. The tire spoon of claim 1, wherein the spoon includes a tine that extends at least partially into the shaft in an axial direction of the shaft, and that is configured to support the spoon when the lever arm is transferring the lever force to the spoon.

8. The tire spoon of claim 1, wherein the force member includes:
a pair of legs configured to receive the pushing force; and
a connecting member that joins the pair of legs so that the force member has a substantially U-like shape.

9. The tire spoon of claim 1, further comprising a support member that is positioned on the shaft in a region of the force member, and that is configured to support the force member and the shaft when the force member is receiving the pushing force.

10. The tire spoon of claim 1, further comprising a leverage base that is connected to the shaft, that is located offset from and is substantially transverse to the shaft, and that is configured to rest on a surface and provide a pivot point during operation of the tire spoon.

11. The tire spoon of claim 1, wherein the spoon includes a grip portion that is configured to at least one of mechanically and frictionally grip at least one of a surface of the tire and a surface of the wheel rim during operation of the tire spoon.

12. The tire spoon of claim 11, wherein the grip portion includes at least one groove configured to mechanically engage at least one of a surface of the tire and a surface of the wheel rim.

13. The tire spoon of claim 12, wherein the at least one groove includes a plurality of grooves that are substantially parallel with each other.

14. The tire spoon of claim 11, wherein the at least one groove is at least partially defined by rounded edges.

15. The tire spoon of claim 1, wherein the spoon further includes:
a protrusion that extends offset from and substantially parallel to the shaft, that is configured to engage and slide along at least one of an edge of the wheel rim and a bead of the tire, and that at least one of (i) inhibits slippage of the tire spoon during operation, and (ii) locates the spoon relative to at least one of the tire and the wheel rim to enable operation of the tire spoon.

16. A tire spoon comprising:
an elongated shaft that includes a first end and a second end opposite the first end, and that defines a lever arm which is distal from the first end;
a spoon extending axially from the first end of the shaft, the spoon defined by stepped groove shape that includes a series of grooves extending substantially transversely to the shaft, and configured to be inserted between a wheel rim and a tire disposed on the wheel rim; and
a force member that extends transversely out from the shaft at a location on the shaft that is proximate to the spoon and between the spoon and the lever arm; wherein:
the lever arm is configured to receive a lever force and transfer the lever force to the spoon;
the force member is configured to receive a pushing force and transfer the pushing force to the spoon; and
the spoon, when receiving the lever force and pushing force, is configured to ratchet the tire via the stepped groove shape in order to move between the tire and the wheel rim.

17. The tire spoon of claim 16, wherein the force member includes a pair of members extending radially from the shaft in opposite directions.

18. The tire spoon of claim 16, further comprising an additional spoon extending axially from the second end of the shaft.

19. The tire spoon of claim 16, wherein the shaft has a length from about 2 feet to about 8 feet.

20. A tire spoon, comprising:
a spoon that extends from a first end of the shaft, that is configured to be inserted between a wheel rim and a tire disposed on the rim, and that includes a grip portion having at least one groove configured to grip at least one of a surface of the tire and a surface of the wheel rim; and
an elongated shaft defining a lever arm that is distal from the spoon and that is configured to receive a lever force and transfer the lever force to the spoon which enables the spoon to flex a portion of the tire about the wheel rim.
